(19) United States
(12) Patent Application Publication
(10) Pub. No.: US 2009/0172958 A1
(43) Pub. Date: Jul. 9, 2009

(54) Pivot inhibiting razor storage case

(76) Inventors: John Prudden, JR., Essex, MA (US); Kelly Daniel Bridges, Quincy, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/008,057

(22) Filed: Jan. 8, 2008

(51) Int. Cl. B26B 21/40

(52) U.S. Cl. 30/539; 30/541

(57) ABSTRACT

A wet shaving razor case suitable for storage of a razor having a cartridge and adjoining handle. The cartridge is pivotal about a pivot axis with respect to the handle. The case includes a lower portion and an upper portion. The upper portion includes a handle-receiving recess and is removably secured to the lower portion between an open position and a closed position. When in the closed position the cartridge is positioned within the case, the handle extends from the case and the case inhibits the cartridge from pivoting with respect to the handle.

### FIELD OF THE INVENTION

This invention relates to a wet shaving razor case that is suitable for storage of a razor having a cartridge and adjoining handle.

### BACKGROUND OF THE INVENTION

Over the years, consumers have become more mobile in their daily lives. This becomes even more apparent as the goods that are commonly used by consumers are tailored for improved mobility and easy travel by manufacturers that recognize this behavior change. One consumer area that has followed this trend is wet shaving razors in that a number of razors are intended for a relatively limited number of uses (referred to as “disposable”) while others are in the form of systems that comprise a longer term use handle that is joined to a removably disposable cartridge. With respect to both types of razor products, it is becoming more commonplace for such razors to incorporate a pivot mechanism allowing the cartridge to pivot with respect to the handle. As manufacturers strive to present consumers with a pivoting mechanism, which provides an improved shave, it is clear that there is a need for a razor case that is suitable for such razors during transport and/or storage. In particular, there is a need for a razor storage case that is suitable for 1) storing the razor in a manner that protects a consumer from unintended contact with the cutting edges of the blades during transport and/or storage, 2) protecting the cutting edges of the blades from dulling by unintended contact during such transport and/or storage, and 3) protecting the pivoting mechanism from damage during transport and/or storage.

### SUMMARY OF THE INVENTION

In accordance with the present invention, a wet shaving razor case suitable for storage of a razor having a cartridge and adjoining handle is provided. The cartridge is pivotal about a pivot axis with respect to the handle. The case comprises a lower portion and an upper portion. The lower portion comprises a handle rest. The upper portion comprises a handle-receiving recess defined by a perimeter and is removably secured to the lower portion between an open position and a closed position. When in the closed position the cartridge is positioned within the case, the handle rest and the perimeter of the handle-receiving recess form an enclosure from which the handle extends from the case and inhibits the cartridge from pivoting about the pivot axis with respect to the handle.

The perimeter surface of said handle-receiving recess and the handle rest engage the handle while the case is in the closed position. A portion of the lower member engages the handle while the case is in the closed position.

The upper portion may be removably secured to the lower portion via a hinge. The upper portion may be removably secured to the lower portion via a snap fit connection.

The lower portion may also comprise a plurality of guides to minimize movement of the cartridge within the lower portion.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a perspective view of a razor which may be stored in the storage case of the present invention.

FIG. 2 is a top isometric view of a storage case of the present invention in an opened position.

FIG. 3 is a right side elevational view of the storage case of FIG. 1 in an opened position.

FIG. 4 is right side elevational view of a storage case of the present invention in a closed position.

FIG. 5 is an expanded view of a first closure member cooperating with a second closure member as described in the present invention.

FIG. 6 is a partially cut away right side elevational view of a storage case of the present invention in a closed position housing a razor.

FIG. 7 is an exploded view of another storage case of the present invention shown in the open position.

FIG. 8 is a bottom isometric view of the upper portion of the storage case of FIG. 7.

FIG. 9 is a top perspective view of the storage case of FIG. 7 in a closed position housing a razor.

### DETAILED DESCRIPTION OF THE INVENTION

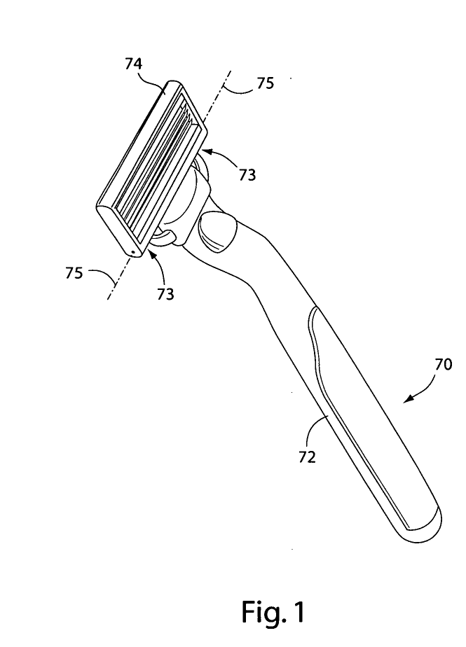

Referring to FIG. 1 there is shown a wet shaving razor 70. Wet shaving razor 70 comprises a handle 72 and a cartridge 74 joined to handle 72. The razor 70 may be disposable where the handle 72 and cartridge are disposed of after use. Alternatively, the razor 70 may be in the form of a system that comprises a longer term use handle 72 that is reused and a removably disposable cartridge 74 that is disposed after use and replaced with a new cartridge. The cartridge 74 is pivotal about a pivot axis 75 with respect to handle 72. A pivot mechanism 73 permits the cartridge 74 to pivot about pivot axis 75 with respect to handle 72.

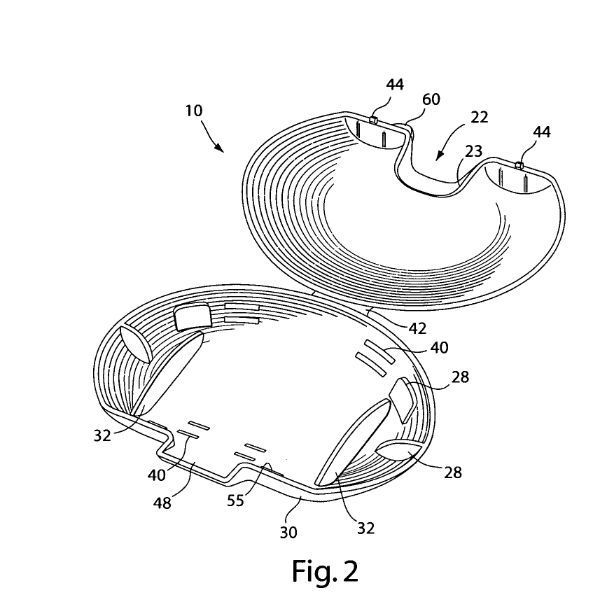

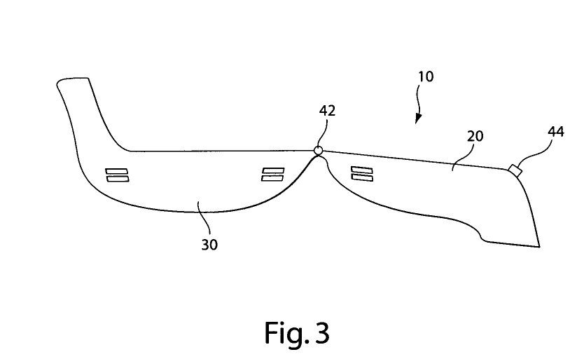

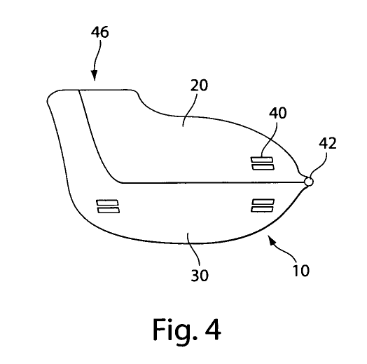

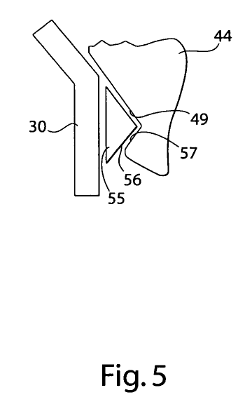

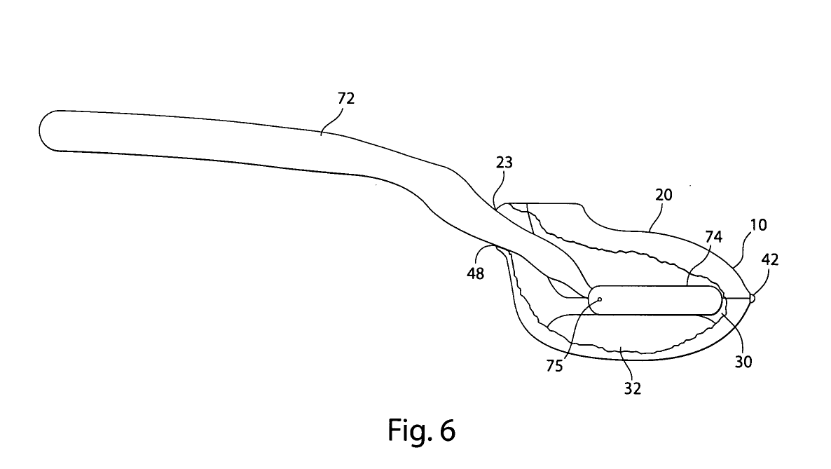

Referring to FIGS. 2-6, there is shown a wet shaving razor case 10 suitable for storage of a razor 70 having a cartridge 74 and an adjoining handle 72. The case comprises an upper portion 20 and a lower portion 30 removably secured to the upper portion. The upper portion 20 comprises a handle-receiving recess 22. The lower portion 30 comprises guides 32 that provide clearance between a razor cartridge 74 and an interior surface of the lower portion 30 of the case 10. This clearance allows for potential drying of any shaving aid that is integrated within the cartridge and is also useful in preventing unnecessary wear of a cutting edge of a shaving blade that is included in the razor cartridge. Guides 28 help to center the cartridge within the lower portion 30.

Optional vent(s) 40 are disposed in the upper portion 20 and the lower portion 30 is shown. One or more vents 40 may be particularly useful for inclusion into the case to aid in evaporation and/or drainage of water or additional fluids used during a shaving experience. The ability of the case to “breathe” may also extend the life of any shaving aid that is integrated with a stored razor cartridge.

The upper portion 20 of the case 10 is removably secured to the lower portion 30. In the embodiment shown in FIGS. 2-6, the joinder between the upper portion 20 and the lower portion 30 results from the presence of a hinge 42. This hinge 42 may present itself in the form of a living hinge, a multi-component cooperating hinge (e.g., with parts from the upper portion interlocking with parts from the lower portion). There may also be a pinning member present that slides through the interlocking parts of the lower and upper portions and that acts to maintain contact between the respective parts and serves as a center of axis for the hinged joint.

A closure system that secures the case 10 in a closed position involves cooperation between a first closure member 44 that is disposed at a periphery of the upper portion 20 and a second closure member 55 that is positioned along a mating periphery of the lower portion 30. The second closure member 55 has an active restraining surface 56 that engages with a rear notch 49 on first closure member 44 that comprises a snap surface 57. The snap fit connection between the first closure member 44 and the second closure member 55 removably secures the upper portion 20 to the lower portion 30. As consistent downward pressure is applied by the user down upon the upper portion 20 or upward pressure from below onto the lower portion 30 to effect closure of the case 10, the second closure member 55 is forced to engagedly slip into a rear notch 49 on the rear of the first closure member 44. In certain embodiments, there may be a plurality of first closure members 44 and corresponding second closure members 55 to improve securing of the closure between the upper portion 20 and the lower portion 30.

The case 10 comprises a handle-receiving recess 22 in the upper portion 20. The handle-receiving recess 22 provides an opening for razor handle 72 that allows the handle to protrude or extend from the case 10 when the cartridge 74 is positioned within case 10 while the case 10 is in the closed position. When the case is in the closed position, the case inhibits the cartridge 74 from pivoting about its' pivot axis 75 with respect to the handle 72. When the upper portion 20 is closed upon the lower portion 30, an enclosure 46 is formed by the perimeter surface 23 of the handle-receiving recess 22 and a handle rest 48, which is disposed toward the rear of the lower portion 30. The perimeter surface 23 and the handle rest 48 engage the handle 72 while the case 10 is in the closed position to inhibit the cartridge 74 from pivoting about its' pivot axis 75 with respect to the handle. This protects the pivot mechanism from damage during transport and/or storage.

The upper portion 20 may comprise an opening tab 60 to facilitate a user in releasing the upper portion 20 from the lower portion 30 in preparation for shaving. The opening tab 60 may be disposed adjacent the handle-receiving recess 22 and may be present on both sides of such recess 22.

In the embodiment of FIGS. 2-6, the complete upper portion 20 and lower portion 30 along with hinge 42 are integrally molded into a single component. Alternatively, the lower portion 30 and the upper portion 20 may each be molded separately and later joined via hinge 42.

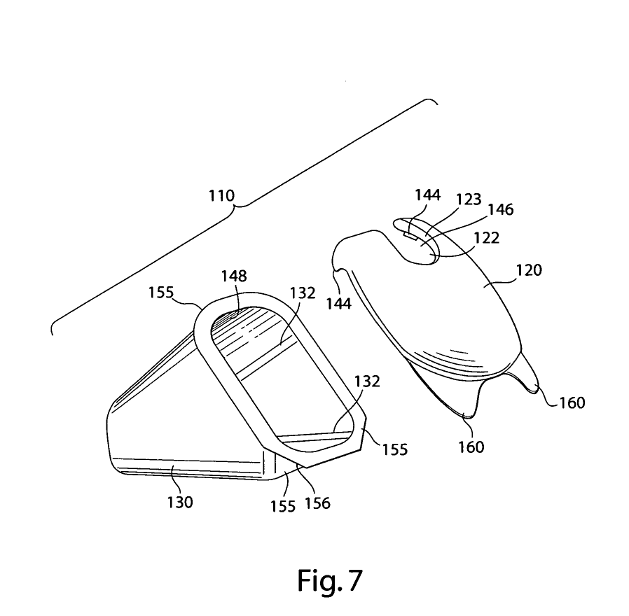

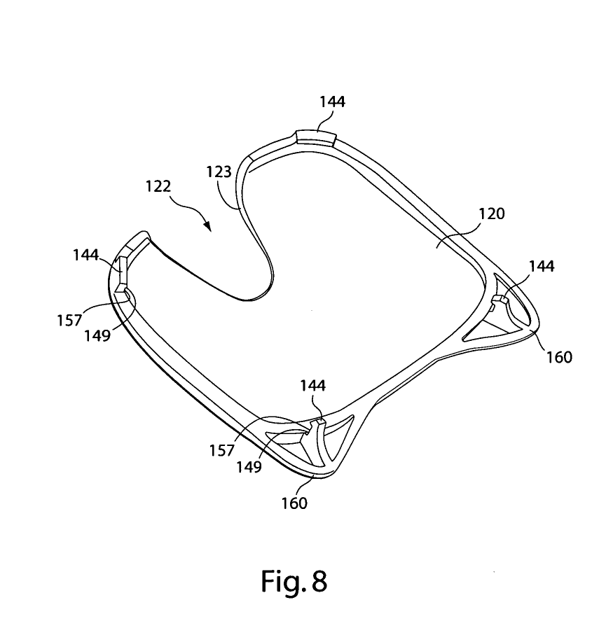

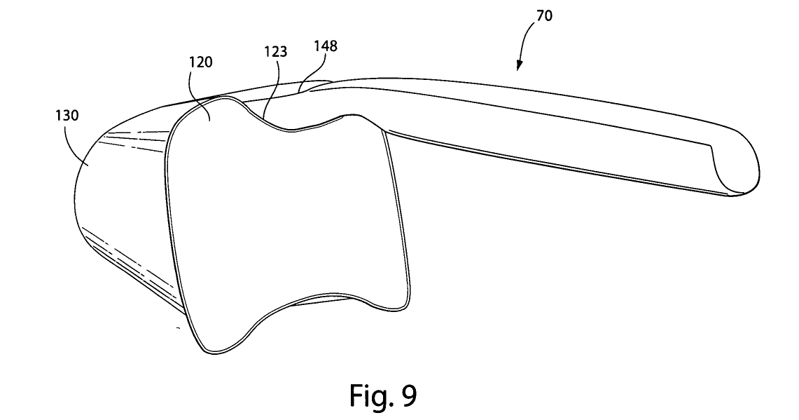

Referring to FIGS. 7-9, there is shown a wet shaving razor case 110 suitable for storage of a razor 70 having a cartridge and an adjoining handle similar to that shown in FIG. 1. The case 110 comprises an upper portion 120 and a lower portion 130 removably secured to the upper portion 120. The upper portion 120 comprises a handle-receiving recess 122. The lower portion 130 comprises guides 132 that direct the razor cartridge into the lower portion 130 of the case 110.

The upper portion 120 of the case 110 is removably secured to the lower portion 130. In the embodiment shown in FIGS. 7-9, the joinder between the upper portion 120 and the lower portion 130 is such that the two portions are completely separated from one another in the open position.

The closure system that secures the case 110 in a closed position involves cooperation between first closure members 144 that are disposed at a periphery of the upper portion 120 and second closure members 155 that are positioned along a mating periphery of the lower portion 130. The second closure member 155 has an active restraining surface 156 that engages with a notch 149 on first closure member 144 that comprises a snap surface 157. The snap fit connection between the first closure members 144 and the second closure members 155 removably secures the upper portion 120 to the lower portion 130. As consistent downward pressure is applied by the user down upon the upper portion 120 or upward pressure from below onto the lower portion 130 to effect closure of the case 110, the second closure member 155 is forced to engagedly slip into notch 149 on the first closure member 144.

The case 110 comprises a handle-receiving recess 122 in the upper portion 120. The handle-receiving recess 122 provides an opening for razor handle that allows the handle to protrude or extend from the case 110 when the cartridge is positioned within case 110 while the case 110 is in the closed position. When the case 110 is in the closed position, the case inhibits the cartridge from pivoting about its' pivot axis with respect to the handle. When the upper portion 120 is closed upon the lower portion 130, an enclosure 146 is formed by the perimeter surface 123 of the handle-receiving recess 122 and a handle rest 148, which is disposed toward the rear of the lower portion 130. The perimeter surface 123 and the handle rest 148 engage the handle while the case 110 is in the closed position to inhibit the cartridge from pivoting about its' pivot axis with respect to the handle. This protects the pivot mechanism from damage during transport and/or storage.

The upper portion 120 may comprise opening tabs 160 to facilitate a user in releasing the upper portion 120 from the lower portion 130 in preparation for shaving. The opening tabs 160 may be disposed opposite the handle-receiving recess 122.

In the embodiment of FIGS. 7-9, the upper portion 120 and lower portion 130 are each molded separately.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A wet shaving razor case suitable for storage of a razor having a cartridge and adjoining handle, said cartridge being pivotal about a pivot axis with respect to said handle, said case comprising:
a. a lower portion comprising a handle rest and;
b. an upper portion comprising a handle-receiving recess defined by a perimeter and being removably secured to said lower portion between an open position and a closed position, when in said closed position said cartridge is positioned within said case, said handle rest and said perimeter of said handle-receiving recess forming an enclosure from which said handle extends from said case and said handle rest and said perimeter engaging said handle inhibiting said cartridge from pivoting about said pivot axis with respect to said handle.

2. The case of claim 1 wherein a portion of said lower member engages said handle in said closed position.

3. The case of claim 1 wherein said upper portion is removably secured to said lower portion via a hinge.

4. The case of claim 1 wherein said upper portion is removably secured to said lower portion via a snap fit connection.

5. The case of claim 1 wherein said lower portion further comprises a plurality of guides to minimize movement of said cartridge within said lower portion.
